(19) United States
(12) Patent Application Publication
(10) Pub. No.: US 2007/0106734 A1
(43) Pub. Date: May 10, 2007

(54) Incentive driven subscriber assisted spam reduction

(75) Inventors: Manish W. Mahajan, Sunrise, FL (US); John M. Burgan, North Palm Beach, FL (US); Swetal A. Patel, Plantation, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/271,407

(22) Filed: Nov. 10, 2005

(51) Int. Cl. G06F 15/16

(52) U.S. Cl. 709/206

(57) ABSTRACT

A system (100) comprising a server (120) and a method (300) for limiting proliferation of unwanted electronic messages. The server can receive a notification from a first user identifying a first electronic message (125) as Spam and compare parameters associated with the first electronic message against Spam criteria. Responsive to the parameters meeting the Spam criteria, other instances of the first electronic message can be blocked from being sent to other users and a credit notification (135) for an account of the first user can be generated. A second user from whom the Spam originated can be added to a blocked sender list of the first user. Responsive to identifying a second electronic message generated from the first user to the second user, a correction charge notification can be generated for the account of the first user.

### BACKGROUND OF THE INVENTION

1. Field of the Invention

The present invention generally relates to electronic messaging and, more particularly, to methods and systems for identifying unwanted messages.

2. Background of the Invention

Unscrupulous people continue to flood communications networks with unwanted electronic messages that are sent to thousands of users in an attempt to force the messages on to people who would not otherwise choose to receive them. Such messages are commonly known as Spam. Most Spam is commercial advertising, often for dubious products or services.

Although Spam is very inexpensive to send, it is nonetheless very costly. Unfortunately, most of the costs associated with Spam are paid by the recipients of the Spam or the carriers that provide communications services through which the Spam is sent. Indeed, Spam ties up valuable network bandwidth, which forces the carriers to expand network capacity by adding expensive communications equipment. Moreover, users of mobile communication devices are oftentimes charged for electronic messaging services on a per message basis. Thus, Spam can increase service fees to users subscribing to such services.

Many communications systems incorporate Spam filters. Spammers are often able to bypass such filters, however, by making their messages un-associatable to the filter rules. Accordingly, the success rate of present Spam filters is limited.

### SUMMARY OF THE INVENTION

The present invention relates to a method for limiting proliferation of unwanted electronic messages. The method can include receiving a notification from a first user identifying a first electronic message as Spam and comparing parameters associated with the first electronic message against Spam criteria. Responsive to the parameters meeting the Spam criteria, other instances of the first electronic message can be blocked from being sent to other users and a credit notification for an account of the first user can be generated. A debit notification also can be generated for an account of a second user from whom the Spam originated.

The method also can include adding the second user to a blocked sender list of the first user. Responsive to identifying a second electronic message generated from the first user to the second user, the first user can be prompted to enter a user input identifying whether the second user is to be removed from the blocked sender list. Responsive to receiving a user input removing the second user from the blocked sender list, a correction charge notification can be generated for the account of the first user. In another arrangement, a correction charge notification for the account of the first user can be generated in response to identifying a second electronic message generated from the first user to the second user.

Further, in response to receiving the user input removing the second user from the blocked sender list, a correction credit notification can be generated for the account of the second user. In another arrangement, a correction credit notification can be generated for the account of the second user in response to identifying the second electronic message generated from the first user to the second user.

The method also can include, for example in response to the parameters not meeting the Spam criteria, tagging other instances of the first electronic message to prompt other users to identify whether the message is Spam. Supplemental user notifications can be received from the other users and, responsive to the determining that the supplemental notifications indicate that the first electronic message is Spam, further instances of the first electronic message can be blocked from being sent.

The present invention also relates to a system that limits proliferation of unwanted electronic messages. The system can include a server that receives a notification from a first user identifying a first electronic message as Spam and compares parameters associated with the first electronic message against Spam criteria. The server can block other instances of the first electronic message from being sent to other users in response to the parameters meeting the Spam criteria. The server also can generate a credit notification for an account of the first user and generate a debit notification for an account of a second user from whom the first electronic message originated.

The server further can add the second user to a blocked sender list of the first user. The server can prompt the first user to enter a user input identifying whether the second user is to be removed from the blocked sender list in response to identifying a second electronic message generated from the first user to the second user. Responsive to receiving a user input removing the second user from the blocked sender list, the server can generate a correction charge notification for the account of the first user and generate a correction credit notification for the account of the second user. In another arrangement, the server can generate a correction charge notification for the account of the first user and generate a correction credit notification for the account of the second user in response to identifying a second electronic message generated from the first user to the second user.

In response to the electronic message parameters not meeting the Spam criteria, the server can tag other instances of the first electronic message to prompt other users to identify whether the message is Spam. The server can receive supplemental user notifications from the other users. In response to the determining that the supplemental notifications indicate that the electronic message is Spam, the server can block further instances of the first electronic message from being sent.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts communications system that is useful for understanding the present invention.

FIG. 2 depicts a block diagram of a server that is useful for understanding the present invention.

FIG. 3 is flowchart that is useful for understanding the present invention.

FIG. 4 is flowchart that is useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

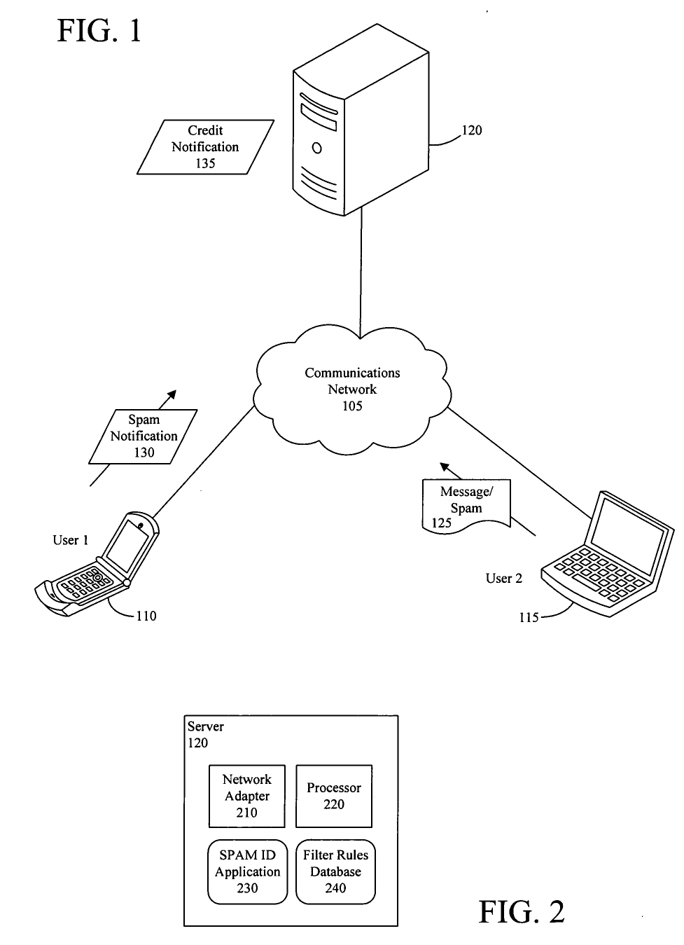

The present invention relates to a method and a system for reducing unwanted electronic messages, commonly known as Spam, in a communications system by providing users incentive to identify such electronic messages. FIG. 1 depicts a communications system 100 that useful for understanding the invention. The communications system 100 can include a communications network 105 through which a first communication device 110 can receive an electronic message (hereinafter “message”) 125 from a second communication device 115.

The first communication device 110 can be, for example, a computer, a personal digital assistant (PDA), a mobile telephone, or any other device that can receive the message 125. Similarly, the second communication device 115 can be a computer, a personal digital assistant (PDA), a mobile telephone, or any other device that can send the message 125. In one arrangement, users of the first and second communication devices 110, 115 can be paying subscribers of the communications system 100.

The communications system 100 also can include a server 120. The server 120 can be, for instance, a component of a message service center, such as a short message service center or a mobile message service center, a component of a router, or implemented in any other system in which it can receive and process a Spam notification 130 and generate a credit notification 135 in accordance with the methods described herein.

FIG. 2 is a block diagram that is useful for understanding the server 120. The server 120 can include one or more network adapters 210, one or more processors 220, and a Spam identification application 230. The network adapter 210 can communicatively link the server 120 to the communications network 105. The network adapter 210 can support IEEE 802 wireless communications, WPA, WPA2, GSM, TDMA, CDMA, WCDMA, Bluetooth, direct wireless communication, TCP/IP, or any other communications protocol compatible with the communications network to which the server 120 is linked.

The Spam identification application 230 can be processed by the processor 220 to evaluate the Spam Notification. In particular, the Spam identification application 230 can cause the processor 220 to evaluate parameters associated with the message to determine whether the message meets Spam criteria. If so, the Spam identification application can cause the processor 220 to generate a credit notification for the account of the first user. The credit notification can be processed by the server 220, forwarded to another server for processing, and/or forwarded to the first user. In addition, the Spam identification application 230 can cause the processor to implement other processes described herein. For example, the Spam identification 230 can cause the processor to update a filter rules database 240. The filter rules database 240 can block other instances of the message identified as Spam from being sent to other users.

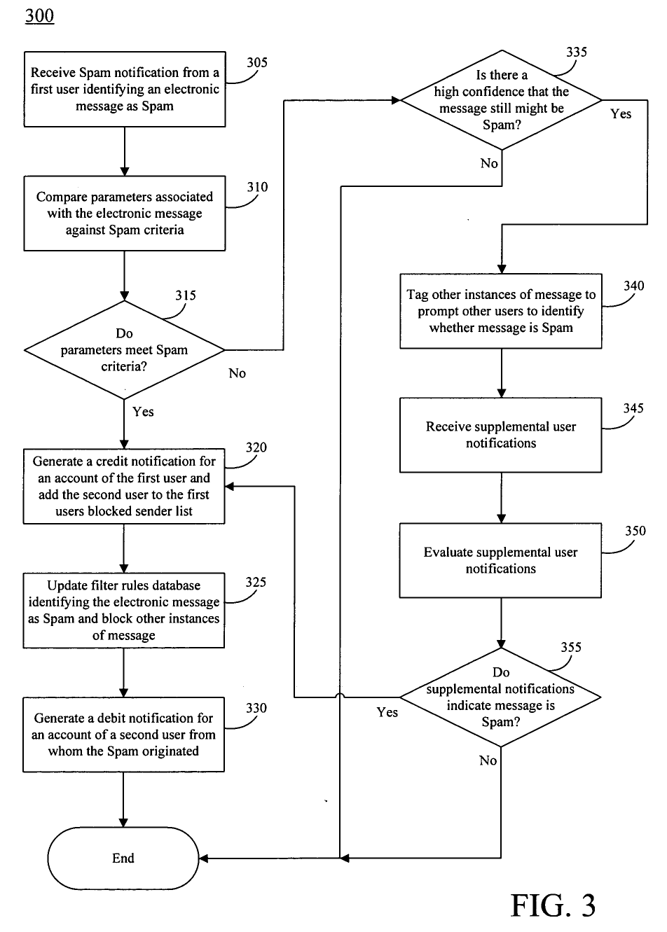

FIG. 3 is flowchart that presents a method 300 which is useful for understanding the present invention. Beginning at step 305, the server can receive the Spam notification from the first user identifying a message as Spam. Proceeding to step 310, the server can compare parameters associated with the message to determine whether to declare the message as Spam. The parameters can be, for example, the number of people to whom other instances of the message was sent, the size of the message, content in the message, or any other parameters that can be analyzed to identify Spam.

Referring to decision box 315, if the parameters meet Spam criteria, the process can proceed to step 320. In this step the server can declare the message to be Spam and generate a credit notification for an account of the first user. The credit notification can cause, for instance, a discount to be applied to a monthly billing statement, a credit to be issued for free file downloads, a credit to be issued for free or discounted use of additional services, or cause any other suitable form of compensation to be generated. The server also can add the second user who generated the message identified as Spam to the first user's blocked sender list. In another arrangement, the second user can be blocked from sending messages to anyone over the communications network 105.

At step 325, a filter rules database can be updated to identify the message as spam. Other instances of the message that remain undelivered can be blocked from being delivered to other users. In one arrangement, the other instances of the message that have been delivered can be removed from user mailboxes. Whether to allow such removal can be a user selectable mailbox option.

In one arrangement, the process can end after step 325. In another arrangement, the process can continue to step 330 and the server can generate a debit notification to the account of the second user who generated the message identified as Spam. The debit can appear as an additional charge on a monthly billing statement, or appear on a separate invoice.

Referring again to decision box 315 and decision box 335, if the parameters do meet Spam criteria, but there still is a high confidence level that the message might be Spam, the process can continue to step 340 where other instances of the message are tagged to prompt other users to identify whether the message is Spam. At step 345, the server can receive supplemental user notifications from the other users indicating whether the message is Spam. At step 350, the supplemental user notifications can be evaluated. For example, a percentage of supplemental notifications received which indicate that the message is Spam can be determined.

Referring to decision box 355, if the supplemental user notifications indicate that the message is Spam, for instance a minimum number of user notifications have been received and a minimum percentage of these notifications identify the message as Spam, then the process can continue at step 320, which has been described. If the supplemental notifications do not indicate the message is Spam, or at decision box 335 there was not a high confidence of the message being Spam, the process can end.

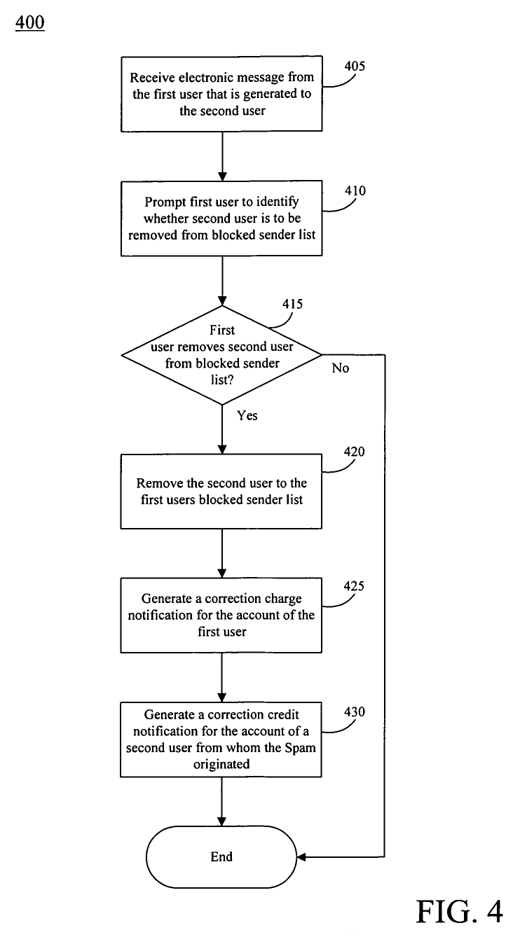

The compensation aspect of the invention may encourage unscrupulous users to attempt to exploit the Spam identification services. Accordingly, the invention also can include provisions for generating correction charges. FIG. 4 is flowchart that presents a method 400 that is useful for understanding such a process. The method 400 can begin in a state in which the first user has identified a message generated by the second user as Spam, and the second user has been added to the block sender list of the first user.

At step 405, the server can receive a message being sent from the first user to the second user. At step 410, the first user can be prompted to identify whether the second user is to be removed from the first user's blocked sender list. Referring to decision box 415 and step 420, if the first user chooses to remove the second user from the blocked sender list, the second user can be removed. However, this can indicate that the first user does not consider the second user to be a true source of Spam. Accordingly, in response to removal of the second user from the first user's blocked sender list, the process can proceed to step 425 and a correction charge can be generated for the account of the first user to offset the credit that may have been previously issued. In one arrangement, the correction charge can be greater in value than the original credit to dissuade users from falsely reporting Spam. If a debit has been applied to the account of the second user, a correction credit can be generated to offset the debit, as shown in step 430.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. conmmunicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A method for limiting proliferation of unwanted electronic messages, comprising:
receiving a notification from a first user identifying a first electronic message as Spam;
comparing parameters associated with the first electronic message against Spam criteria;
responsive to the parameters meeting the Spam criteria, blocking other instances of the first electronic message from being sent to other users; and
generating a credit notification for an account of the first user.

2. The method according to claim 1, further comprising adding a second user from whom the Spam originated to a blocked sender list of the first user.

3. The method according to claim 2, further comprising:
responsive to identifying a second electronic message generated from the first user to a second user from whom the first electronic message originated, prompting the first user to enter a user input identifying whether the second user is to be removed from the blocked sender list; and
responsive to receiving a user input removing the second user from the blocked sender list, generating a correction charge notification for the account of the first user.

4. The method according to claim 1, further comprising:
responsive to identifying a second electronic message generated from the first user to a second user from whom the first electronic message originated, generating a correction charge notification for the account of the first user.

5. The method according to claim 1, further comprising generating a debit notification for an account of a second user from whom the first electronic message originated.

6. The method according to claim 5, further comprising:
responsive to identifying a second electronic message generated from the first user to a second user from whom the first electronic message originated, prompting the first user to enter a user input identifying whether the second user is to be removed from the blocked sender list; and
responsive to receiving a user input removing the second user from the blocked sender list, generating a correction credit notification for the account of the second user.

7. The method according to claim 5, further comprising:
responsive to identifying a second electronic message generated from the first user to a second user from whom the first electronic message originated, generating a correction credit notification for the account of the second user.

8. The method according to claim 1, further comprising:
responsive to the parameters not meeting the Spam criteria, tagging other instances of the first electronic message to prompt other users to identify whether the message is Spam;
receiving supplemental user notifications from the other users; and
responsive to the determining that the supplemental notifications indicate that the first electronic message is Spam, blocking further instances of the first electronic message from being sent.

9. A system that limits proliferation of unwanted electronic messages, comprising:
a server that receives a notification from a first user identifying a first electronic message as Spam, compares parameters associated with the first electronic message against Spam criteria, blocks other instances of the first electronic message from being sent to other users in response to the parameters meeting the Spam criteria, and generates a credit notification for an account of the first user.

10. The system of claim 9, wherein the server further adds a second user from whom the Spam originated to a blocked sender list of the first user.

11. The system of claim 10, wherein the server prompts the first user to enter a user input identifying whether the second user is to be removed from the blocked sender list in response to identifying a second electronic message generated from the first user to a second user from whom the first electronic message originated, and responsive to receiving a user input removing the second user from the blocked sender list, the server generates a correction charge notification for the account of the first user.

12. The system of claim 9, wherein the server further generates a correction charge notification for the account of the first user responsive to identifying a second electronic message generated from the first user to a second user from whom the first electronic message originated.

13. The system of claim 9, wherein the server further generates a debit notification for an account of a second user from whom the first electronic message originated.

14. The system of claim 13, wherein the server further prompts the first user to enter a user input identifying whether a second user from whom the first electronic message originated is to be removed from the blocked sender list in response to identifying a second electronic message generated from the first user to the second user, and generates a correction credit notification for the account of the second user in response to receiving a user input removing the second user from the blocked sender list.

15. The system of claim 13, wherein the server further generates a correction credit notification for the account of the second user from whom the first electronic message originated responsive to identifying a second electronic message generated from the first user to the second user.

16. The system of claim 9, wherein the server further tags other instances of the first electronic message to prompt other users to identify whether the message is Spam in responsive to the parameters not meeting the Spam criteria, receives supplemental user notifications from the other users, and blocks further instances of the first electronic message from being sent in response to the determining that the supplemental notifications indicate that the electronic message is Spam.

17. A machine readable storage, having stored thereon a computer program having a plurality of code sections executable by a machine for causing the machine to perform the steps of:
receiving a notification from a first user identifying a first electronic message as Spam;
comparing parameters associated with the first electronic message against Spam criteria;
responsive to the parameters meeting the Spam criteria, blocking other instances of the first electronic message from being sent to other users; and
generating a credit notification for an account of the first user.

18. The machine readable storage of claim 17, further causing the machine to add a second user from whom the Spam originated to a blocked sender list of the first user.

19. The machine readable storage of claim 18, further causing the machine to prompt the first user to enter a user input identifying whether the second user is to be removed from the blocked sender list in response to identifying a second electronic message generated from the first user to a second user from whom the first electronic message originated; and
generate a correction charge notification for the account of the first user in response to receiving a user input removing the second user from the blocked sender list.

20. The machine readable storage of claim 17, further causing the machine to generate a correction charge notification for the account of the first user in response to identifying a second electronic message generated from the first user to a second user from whom the electronic message originated.
